(19) United States
(12) Patent Application Publication
(10) Pub. No.: US 2009/0022561 A1
(43) Pub. Date: Jan. 22, 2009

(54) ROTARY CUTTING TOOL

(76) Inventor: John Richard WINEBRENNER, Latrobe, PA (US)

Correspondence Address: REED SMITH LLP, P.O. BOX 488, PITTSBURGH, PA, 15230-0488, US

(21) Appl. No.: 11/779,616

(22) Filed: Jul. 18, 2007

(51) Int. Cl. B23B 51/02

(52) U.S. Cl. 408/230

(57) ABSTRACT

A rotary cutting tool especially adapted for cutting composite materials. The geometry of the cutting tool provides cutting forces that are controlled and directed to the inside of the hole being drilled. The cutting tool of one embodiment of the present invention preferably has a through hole or bore extending axially through the cutting tool. The through hole is preferably operatively connectable to a fluid source such as a vacuum or coolant source.

### FIELD OF INVENTION

The present invention relates to a rotary cutting tool and, more particularly to a rotary cutting tool primarily for cutting composite materials.

### BACKGROUND OF THE INVENTION

Rotary cutting tools are commonly used in manufacturing. One example of a conventional rotary cutting tool includes a power drill having a cutting portion having helical or spiral flutes. In industries such as the aircraft industry, challenges arise from drilling holes in composite materials such as metal composites, carbon composites and matrix stacked materials. The drilling of materials such as composite materials produces unwanted particles, chips and dust. Composite dust is very abrasive and may cause premature tool wear if not controlled. Additionally, uncontrolled particles, chips and dust may cause damage to the finished hole. A typical conventional rotary cutting tool is designed to begin cutting a hole at the center of the hole. This provides cutting forces that are directed outward and down against material fiber layers which may cause the material to delaminate. Material chips and debris are typically forced against the finished hole causing damage to the composite material.

### SUMMARY OF THE PRESENT INVENTION

In accordance to at least one embodiment of the present invention, the present invention provides a rotary cutting tool especially adapted for cutting composite materials. One of skill in the art would appreciate the cutting tool of the present invention is not, however, limited to the cutting of composite materials.

One feature of the present invention is the geometry of the cutting tool provides cutting forces that are controlled and directed to the inside of the hole being drilled, while in conventional cutting tools, forces are directed towards the outside of the hole. The cutting tool of one embodiment of the present invention preferably has a through hole or bore extending axially through the cutting tool. The through hole is preferably operatively connectable to a fluid source such as a vacuum or coolant source.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a side view showing a preferred embodiment of the rotary cutting tool of the present invention, from the perspective shown in FIG. 4 (the view is in the direction of line 1-1 in FIG. 4);

FIG. 2 is a side view of the rotary cutting tool of FIG. 1 rotated 90° about the tool's axial center line from the side view of FIG. 1 (the view is in the direction of line 2-2 in FIG. 4);

FIG. 3 is a side view of the rotary cutting tool of FIG. 1 rotated 120° about the tool's axial center line from the side view of FIG. 1 (the view is in the direction of line 3-3 in FIG. 4); and

FIG. 4 is an end view of the rotary cutting tool of FIG. 1 (the view is in the direction of line 4-4 in FIG. 2).

### DETAILED DESCRIPTION OF THE INVENTION

It is to be understood that the figures and descriptions of the present invention have been simplified to illustrate elements that are relevant for a clear understanding of the invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided hereinbelow with reference to the attached drawings, wherein like numerals designate like components.

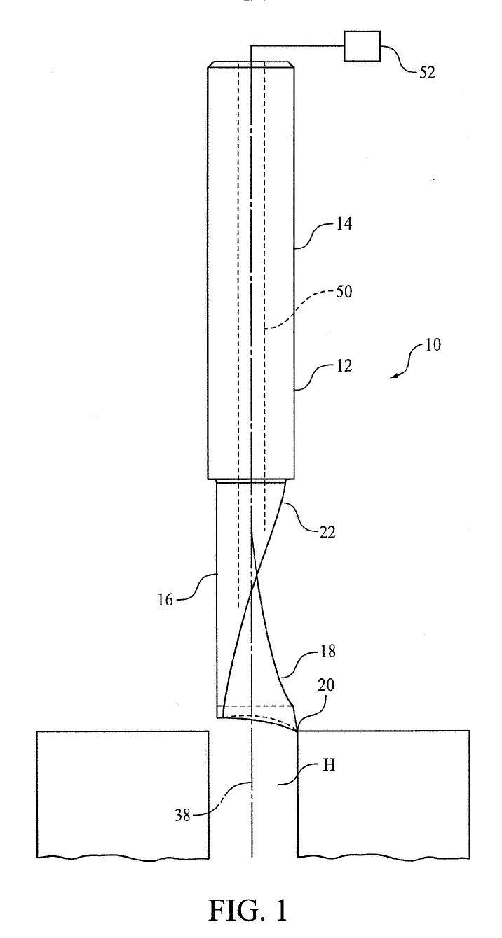

There is illustrated in FIGS. 1-4 a rotary cutting tool 10 according to a preferred embodiment of the present invention. The cutting tool is adapted for use in cutting carbon composite materials, ceramic matrix composite materials, and metal matrix composite materials. The cutting tool of the present invention is especially ideal for composite stack drilling.

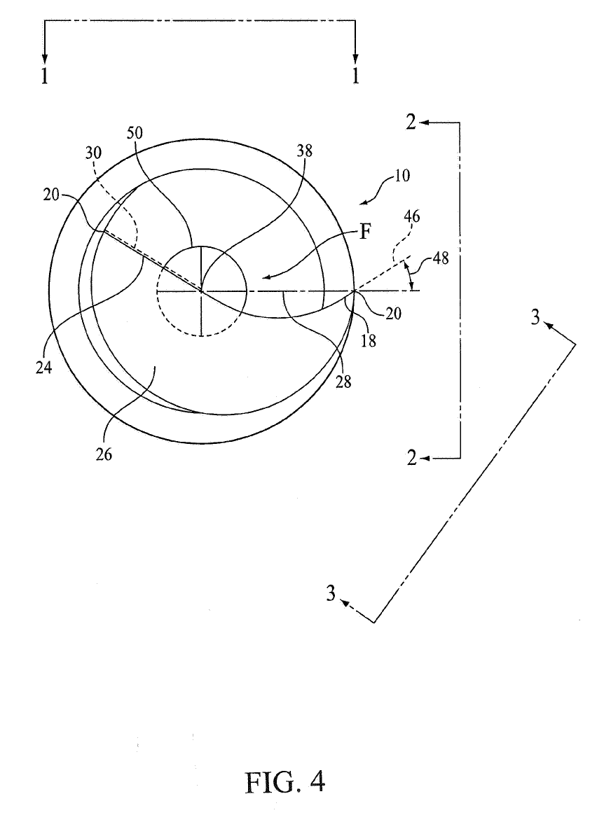

Cutting tool 10 includes a tool body 12 having a cylindrical shank portion 14 and a cutting portion 16. Cylindrical shank portion 14 is adapted to mate with a receiving portion of a drill or cutting machine (not illustrated). Cutting portion 16 has a single primary cutting edge 18 extending from shank portion 14 to a tip 20 and spiraling approximately 90° from shank portion 14 to tip 20 in a right handed spiral. A right handed spiral is shown here by way of example only, one of skill in the art would appreciate a left hand spiral could be used with a drill rotating in the opposite direction. Cutting portion 16 also has a secondary trailing edge 22 corresponding to primary cutting edge 18. Cutting portion 16 includes a concave cutting surface 24 (FIG. 4) between cutting edge 18 and secondary edge 22.

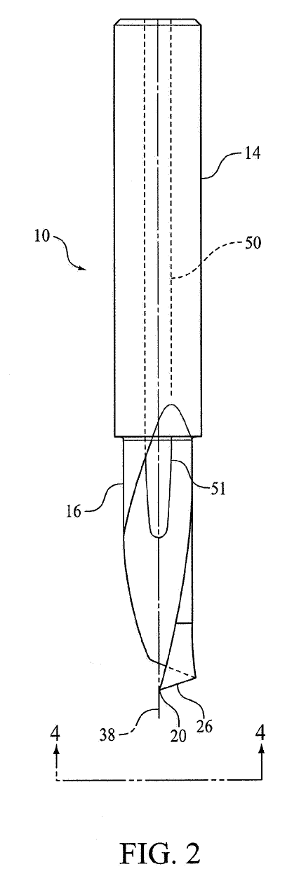

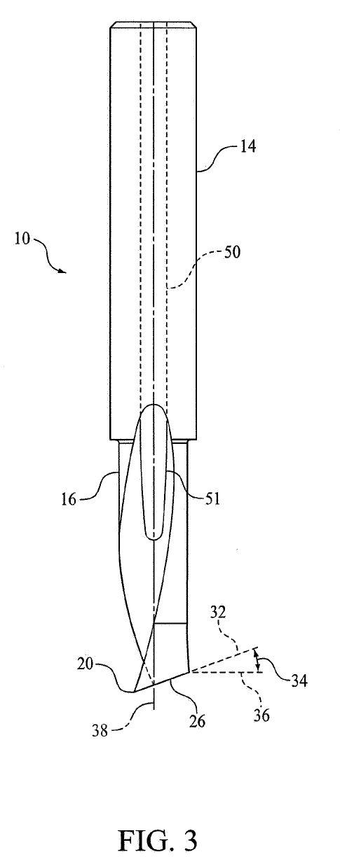

Tip 20 has an outer portion 26 having a substantially crescent shape (FIGS. 2-4). A radius 28 (shown in phantom line) of outer portion 26 at cutting edge 18 is greater than a radius 30 (shown in phantom line) of outer portion 26 at secondary edge 22. In operation, cutting edge 18 at outer portion 26 starts making a hole H in the material at the outside edge of the hole H such that cutting edge 18 provides the initial contact with the material being cut (FIG. 1). Outer portion 26 lies in a plane 32 (shown in phantom line) and preferably has a primary relief angle 34 (FIG. 3) when measured with respect to a plane 36 (shown in phantom line) normal to an axial center line 38 of cutting tool 10. Primary relief angle 34 is in the range of 5° and 50°, more preferably in the range of 5° and 40°, even more preferably in the range of 12° and 35°, and most preferably in the range of 12° and 20°. Primary relief angle 34 controls the tool life of the cutting edge. If the primary relief angle is greater than the upper limit of the present invention, the cutting edge will become weak and may chip causing premature tool failure. If the primary relief angle is less than the lower limit of the present invention, the tool may start to wear in a reverse waterfall type of mechanism, which also causes premature tool failure.

As shown best in FIG. 4, when cutting tool 10 is viewed from a transverse end view, radial line 28 is drawn from axial center line 38 outwardly through the cutting edge 18. Concave cutting surface 24 passes through axial center line 38, thus, providing a much lower force on the material being cut. A tangential line 46 (shown in phantom line) is drawn tangential to concave cutting surface 24 at its intersection with cutting edge 18. The geometry of the tool design of the present invention provides a high positive rake angle providing a free machining tool. The positive cutting action provides high shear to cleanly shear each composite fiber. The positive radial rake angle 48 of cutting tool 10 is measured between a line going through radial line 28 and tangential line 46. Positive rake angle 48 is in the range of 5° and 50°, more preferably in the range of 5° and 45°, even more preferably in the range of 10° and 40°, and most in the range of preferably 10° and 30°. The rake angle of the present invention helps provide positive cutting forces, illustrated by arrow F in FIG. 4, which direct debris, dust and chips inwardly towards the axial center line 38 of cutting tool 10. In the present invention, these cutting forces are controlled and directed towards the inside of the hole being drilled, while in conventional cutting tools, cutting forces are directed towards the outside of the hole.

Cutting tool 10 preferably has a through hole or bore 50 extending axially through cutting tool 10 from a distal end of shank portion 14 through a recessed portion 51 of concave cutting surface 24. The recessed portion 51 extends into concave cutting surface 24 but not all the way to tip 20. Through hole 50 is operatively connectable to a fluid source 52 (FIG. 1). Preferably, source 52 is a vacuum source for conducting dust and chips away from the hole H being drilled and outwardly through hole 50. In this case, source 52 is operatively connectable to cutting tool 10 utilizing a vacuum ring (not illustrated) as is known in the art. Alternatively, source 52 may be a coolant source and hole 50 serves as a passageway for the coolant. As discussed above, the design of cutting edge 18 helps direct chips and dust toward hole 50.

Cutting tool 10 is preferably formed from polycrystalline diamond (PCD), tool steel, tungsten carbide or ceramic. Cutting tool 10 may provided with a protective tool coating such as titanium diboride, titanium nitride, titanium aluminum nitride, chromium nitride and polycrystalline coating to provide thermal protection to the base material

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed is:

1. A cutting tool adapted for cutting a composite material comprising:
a tool body having an axial center line and including a shank portion and a cutting portion; and
a primary cutting edge on the cutting portion having a means for directing cutting debris towards the axial center line.

2. The cutting tool of claim 1, wherein the means for directing cutting debris towards the axial center line comprises a positive rake angle in the range of 5° and 50°.

3. The cutting tool of claim 2, wherein the positive rake angle is in the range of 5° and 45°.

4. The cutting tool of claim 3, wherein the positive rake angle is in the range of 10° and 40°.

5. The cutting tool of claim 4, wherein the positive rake angle is in the range of 10° and 30°.

6. The cutting tool of claim 1, wherein an outer portion of the cutting portion has a primary relief angle in the range of 5° and 50°.

7. The cutting tool of claim 6, wherein the primary relief angle is in the range of 5° and 40°.

8. The cutting tool of claim 7, wherein the primary relief angle is in the range of 12° and 35°.

9. The cutting tool of claim 8, wherein the primary relief angle is in the range of 12° and 20°.

10. The cutting tool of claim 1, further comprising a hole extending axially through the axial center line.

11. The cutting tool of claim 10, further comprising a recessed portion on the cutting portion extending from the hole and ending intermediate a tip portion of the cutting portion.

12. The cutting tool of claim 10, wherein the axial hole is adapted to be connected to a vacuum source.

13. The cutting tool of claim 10, wherein the axial hole is adapted to be connected to a coolant source.

14. The cutting tool of claim 1, wherein, in operation, the primary cutting edge provides the initial contact with the material being cut.

15. A cutting tool for cutting a material comprising:
a tool body having an axial center line and including a shank portion and a cutting portion; and
a primary cutting edge on the cutting portion having a positive rake angle in the range of 5° and 50°.

16. The cutting tool of claim 15, wherein the positive rake angle is in the range of 5° and 45°.

17. The cutting tool of claim 16, wherein the positive rake angle is in the range of 10° and 40°.

18. The cutting tool of claim 17, wherein the positive rake angle is in the range of 10° and 30°.

19. The cutting tool of claim 15, wherein an outer portion of the cutting portion has a primary relief angle in the range of 5° and 50°.

20. The cutting tool of claim 19, wherein the primary relief angle is in the range of 5° and 40°.

21. The cutting tool of claim 20, wherein the primary relief angle is in the range of 12° and 35°.

22. The cutting tool of claim 21, wherein the primary relief angle is in the range of 12° and 20°.

23. The cutting tool of claim 15, further comprising a hole extending axially through the axial center line.

24. The cutting tool of claim 23, further comprising a recessed portion on the cutting portion extending from the hole and ending intermediate a tip portion of the cutting portion.

25. The cutting tool of claim 23, wherein the axial hole is adapted to be connected to a vacuum source.

26. The cutting tool of claim 23, wherein the axial hole is adapted to be connected to a coolant source.

27. The cutting tool of claim 15, wherein, in operation, the primary cutting edge provides the initial contact with the material being cut.
